(19) United States
(12) Patent Application Publication
(10) Pub. No.: US 2026/0113552 A1
(43) Pub. Date: Apr. 23, 2026

(54) FUSION OF COALIGNED HYBRID SENSORS IN ARRAY

(71) Applicant: Raytheon Company, Tewksbury, MA (US)

(72) Inventors: Angelo Gregory Scott Gilmore, Boulder, CO (US); Angelika Rutz, Newbury Park, CA (US); Sean P. Kilcoyne, Lompoc, CA (US); Armando Fajardo, Oxnard, CA (US)

(21) Appl. No.: 18/924,497

(22) Filed: Oct. 23, 2024

(51) Int. Cl. H04N 25/79; H04N 23/50; H04N 25/78

(52) U.S. Cl. CPC H04N 25/79; H04N 23/50; H04N 25/78

(57) ABSTRACT

A focal plane array assembly may include a plurality of subarrays that are electrically isolated. Each of the plurality of subarrays may include a one or more detectors and one or more readout integrated circuit (ROIC) subarrays coupled to the one or more detectors. Each ROIC subarray may include a plurality of buttable sides and at least one unbuttable side configured to electrically couple to an interposer or a connector for providing an input to or output from the ROIC subarray. The at least one unbuttable side of each detector may include first and second unbuttable sides. The at least one unbuttable side of each ROIC subarray includes additional peripheral circuitry and input/output pads that are coplanar with the ROIC subarray and is non-coplanar with the one or more detectors.

### TECHNICAL FIELD

This disclosure relates generally to image sensing using focal plane arrays. More specifically, this disclosure relates to the fusion of coaligned hybrid sensors in an array.

### BACKGROUND

Focal plane arrays (FPAs) are light-sensing devices, e.g., sensors, that include an array of pixels that detect and convert light, such as infrared radiation, into electrical signals to capture detailed images in real-time. Some FPAs may come in ultra large format configurations where the FPA includes a significant number of pixels, allowing the FPAs to produce wider fields-of-view and higher-resolution images. However, production of large FPAs leads to low yields due to the size of the arrays.

### SUMMARY

This disclosure relates to the fusion of coaligned hybrid sensors in an array.

In some examples, a focal plane array assembly may include a plurality of subarrays that are electrically isolated. Each of the plurality of subarrays may include a one or more detectors and one or more readout integrated circuit (ROIC) subarrays coupled to the one or more detectors. Each ROIC subarray may include a plurality of buttable sides and at least one unbuttable side configured to electrically couple to an interposer or a connector for providing an input to or output from the ROIC subarray.

Any single one or any combination of the following features may be used with the examples above. Each detector of the one or more detectors may include a 4,000 element-by-4,000 element or larger array. Each subarray may include a first detector, a second detector, a third detector, and a fourth detector. The plurality of buttable sides of each ROIC subarray may include a first buttable side and a second buttable side. The at least one unbuttable side of each ROIC subarray may include a first unbuttable side and a second unbuttable side. Each subarray may include a fifth detector and a sixth detector. The plurality of buttable sides of each ROIC subarray may include a first buttable side, a second buttable side, and a third buttable side. The at least one unbuttable side of each ROIC subarray may include additional peripheral circuitry and input/output pads that are coplanar with the ROIC subarray and is non-coplanar with the one or more detectors.

In other examples, an integrated dewar assembly may include an interposer and a focal plane array assembly including a plurality of subarrays. Each of the plurality of subarrays may include a plurality of detectors and a plurality of ROIC subarrays coupled to the plurality of detectors. Each ROIC subarray may include a plurality of buttable sides and at least one unbuttable side configured to electrically couple to an interposer or a connector for providing an input to or output from the ROIC subarray.

Any single one or any combination of the following features may be used with the examples above. Each of the one or more detectors may include a 4,000 element-by-4,000 element or larger array. Each subarray may include a first detector, a second detector, a third detector, and a fourth detector. The plurality of buttable sides of each of the plurality of ROIC subarrays may include a first buttable side and a second buttable side. The at least one unbuttable side of each of the plurality of ROIC subarrays may include a first unbuttable side and a second unbuttable side. Each subarray may include a fifth detector and a sixth detector. The plurality of buttable sides of each of the plurality of ROIC subarrays may include a first buttable side, a second buttable side, and a third buttable side. The at least one unbuttable side of each of the plurality of ROIC subarrays may include additional peripheral circuitry and input/output pads that are coplanar with the ROIC subarray and is non-coplanar with the one or more detectors.

In still other examples, a method may include producing a plurality of subarray readout integrated circuit (ROIC) substrates, and each of the plurality of ROIC subarrays may include a plurality of buttable sides and at least one unbuttable side configured to electrically couple to an interposer or a connector for providing an input to or output from the ROIC subarray. The method may also include coupling the plurality of ROIC subarrays to one or more detectors using the at least one unbuttable side of each of the ROIC subarrays to form a plurality of gaps disposed between the plurality of buttable sides. The gaps may be configured to electrically isolate adjacent ROIC subarrays of the plurality of ROIC subarrays.

Any single one or any combination of the following features may be used with the examples above. Each detector of the one or more detectors may include a 4,000 element-by-4,000 element or larger array. Each subarray may include a first detector, a second detector, a third detector, and a fourth detector. The plurality of buttable sides of each of the plurality of ROIC subarrays may include a first buttable side and a second buttable side. The at least one unbuttable side of each of the plurality of ROIC subarrays may include a first unbuttable side and a second unbuttable side. Each subarray may include a fifth detector and a sixth detector. The plurality of buttable sides of each of the plurality of ROIC subarrays may include a first buttable side, a second buttable side, and a third buttable side. The at least one unbuttable side of each of the plurality of ROIC subarrays may include additional peripheral circuitry and input/output pads that are coplanar with the ROIC subarray and is non-coplanar with the one or more detectors.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIG. 1 illustrates an example integrated dewar assembly in accordance with this disclosure;

FIG. 2 illustrates an example focal plane array assembly in accordance with this disclosure;

FIG. 3 illustrates an example method to produce a focal plane array assembly in accordance with this disclosure;

FIGS. 4A, 4B, and 4C illustrate an example focal plane array assembly undergoing the method of FIG. 3 in accordance with this disclosure; and

FIG. 5 illustrates another example focal plane array assembly in accordance with this disclosure.

### DETAILED DESCRIPTION

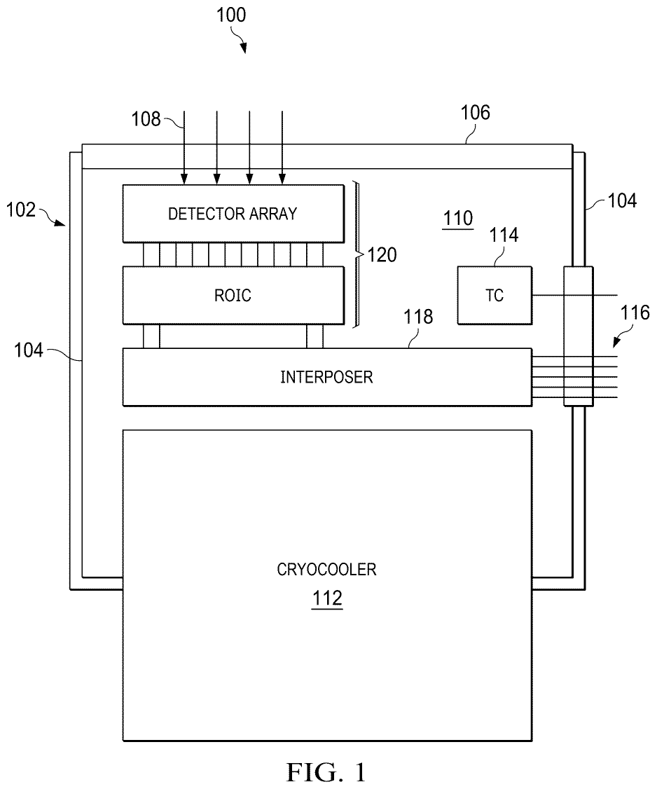

FIGS. 1 through 5, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, focal plane arrays (FPAs) are light-sensing devices that include an array of pixels that detect and convert light, such as infrared (IR) radiation, into electrical signals to capture detailed images in real-time. Some FPAs may come in ultra large format configurations where the FPA includes a significant number of pixels, allowing the FPAs to produce wider fields-of-view and higher-resolution images. However, production of large FPAs leads to low yields due to the size of the arrays. For example, traditional methods of production, e.g., a single large detector coupled to a single large readout integrated circuit substrate or multiple detector arrays hybridized to a single large readout integrated circuit substrate, lead to marketable yields, such as Grade A, Grade B, and Grade C, of less than 10% (while approximately half of the yield fails).

This disclosure provides for the fusion of coaligned hybrid sensors in an array, which can be used to achieve ultra large format FPAs (such as up to 4,000 element-by-4,000 element arrays, 6,000 element-by-6,000 element arrays, or even larger). The ultra large format FPAs can be formed using subarrays that are collocated or coaligned. In some cases, the subarrays may include two-side buttable arrays, where two sides of each subarray may be electrically isolated and disposed adjacent to other subarrays. The subarrays in this configuration may include two unbuttable sides that serve to electrically connect to perimeter circuitry, such as to support one or more functions of the subarray. In other cases, the subarrays may include three-side buttable arrays, where three sides of each subarray may be electrically isolated and disposed adjacent to other subarrays. In these various embodiments, the subarrays are collocated, such as when the buttable sides of the subarrays are disposed adjacent to each other, to produce an ultra large format FPA. As a result, these techniques can significantly improve yield of ultra large format FPAs.

FIG. 1 illustrates an example integrated dewar assembly in accordance with this disclosure. As shown in FIG. 1, the dewar assembly 100 includes a vacuum sealed cryogenic chamber 102 (also known as a Dewar), which may include a double-walled construction 104 and a main optical window 106 (such as one that is substantially transparent to incident IR radiation 108). The volume within the cryogenic chamber 102 and within the double-walled construction 104 can be held at vacuum to thermally isolate a cold volume 110 inside the chamber from the surrounding environment at ambient temperature. For instance, the evacuated chamber and double-walled construction may resist irradiant thermal energy exchange with the surrounding air.

A focal plane array assembly 120 can be positioned in the cold volume 110 inside the cryogenic chamber 102. The focal plane array assembly 120 may include a detector array and a readout integrated circuit (ROIC) that can be supported in contact with or otherwise in thermal communication with a cryocooler 112. A thermocouple 114 may measure the temperature inside the cold volume and feed back the measurement via an electrical wire 116 or other mechanism to a controller in the cryocooler 112.

A number of electrical wires 116 may penetrate the double-walled construction 104. These wires can bring electrical power signals (such as various DC+, DC−, and ground signals) into the chamber. The wires can also bring electrical data input signals (such as gain and bias for the FPA) and data output signals from the detector array and ROIC. The electrical wires 116 may terminate at an interposer 118 on which the focal plane array assembly 120 is mounted. The interposer 118 may also serve to distribute the electrical power signals and data input signals to the detector array and ROIC and to receive electrical signals from the ROIC.

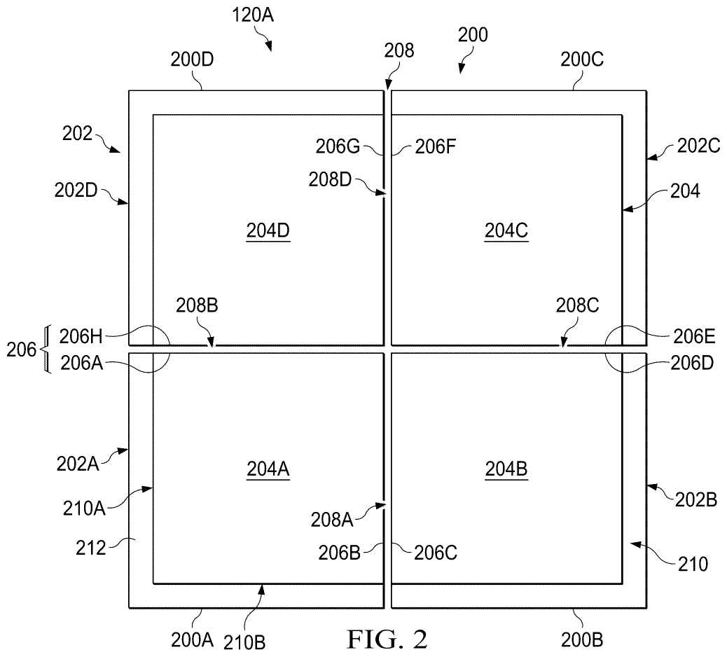

FIG. 2 illustrates an example focal plane array assembly 120A in accordance with this disclosure. For example, the focal plane array assembly 120A may be part of the integrated dewar assembly 100 of FIG. 1. As shown in FIG. 2, the focal plane array assembly 120A can include a plurality of subarrays 200 that are electrically isolated. In this example, the focal plane array assembly 120A is an ultra large format FPA that includes four subarrays 200A-200D. Each of the plurality of subarrays 200 may be a two-side buttable array and can include a ROIC subarray 202 of one or more ROIC subarrays electrically coupled to at least one detector 204. In some embodiments, the at least one detector 204 may include a first detector 204A, a second detector 204B, a third detector 204C, and a fourth detector 204D. Each of the one or more detectors 204 may be a 4,000 element-by-4,000 element array (such as one having about 4,000 rows and 4,000 columns) or larger, and the detectors 204 can be disposed adjacent to each other on the ROIC subarray 202. In alternative embodiments, each of the one or more detectors 204 may be any desired size, such as a 6,000 element-by-6,000 element array or larger, such as an 8,000 element-by-8,000 element array or larger, such as a 10,000 element-by-10,000 element array or larger. In other alternative embodiments, the size of each of the plurality of detectors may be smaller, e.g., include less elements, than a 4,000 element-by-4,000 element array or larger, such as a 2,000 element-by-2,000 element array or smaller.

Each of the one or more ROIC subarrays 202 can include a plurality of buttable sides 206 along a perimeter of each of the one or more ROIC subarrays 202. For example, a first ROIC subarray 202A may include a buttable side 206A and a buttable side 206B, a second ROIC subarray 202B may include a buttable side 206C and a buttable side 206D, a third ROIC subarray 202C may include a buttable side 206E and a buttable side 206F, and a fourth ROIC subarray 202D may include a buttable side 206G and a buttable side 206H.

The one or more ROIC subarrays 202 are separated and electrically isolated from each other by a plurality of gaps 208 between the plurality of buttable sides 206. For example, the first ROIC subarray 202A may be isolated from the second ROIC subarray 202B by a gap 208A between the buttable side 206B and the buttable side 206C, and the first ROIC subarray 202A may be isolated from the fourth ROIC subarray 202D by a gap 208B between the buttable side 206A and the buttable side 206H. The second ROIC subarray 202B may be isolated from the third ROIC subarray 202C by a gap 208C between the buttable side 206D and the buttable side 206E. The third ROIC subarray 202C may be isolated from the fourth ROIC subarray 202D by a gap 208D between the buttable side 206F and the buttable side 206G.

The plurality of gaps 208 can be configured to electrically isolate adjacent detectors of the one or more ROIC subarrays 202. In some cases, the gaps 208 need not be physical gaps but instead may be electrical isolation gaps, such as electrical termination, between adjacent detectors of the plurality of ROIC subarrays 202 such that each subarray may be operated separately. The size of each of the plurality of gaps 208 may be minimal, such as at the sub-micron level, and may be limited by the techniques, such as photolithography, used to produce the components. The gaps 208 electrically separate each of the one or more ROIC subarrays 202, allowing the plurality of subarrays 200 to operate independently while minimizing gaps in imagery captured by the focal plane array assembly 120A.

Each of the one or more ROIC subarrays 202 also includes at least one unbuttable side 210 that is not adjacent to other detectors, such as an unbuttable side 210A and an unbuttable side 210B of the first detector 204A. The at least one unbuttable side 210 is configured to electrically couple to an interposer, e.g., the interposer 118, or a connector for providing an input to or output from the ROIC subarray 202. The at least one unbuttable side 210 of each ROIC subarray 202 includes additional peripheral circuitry 212 and input/output pads that are coplanar with the ROIC subarray 202 and is non-coplanar with the one or more detectors 204. The at least one unbuttable side 210 allows for electrical connections to the one or more ROIC subarrays 202 from the ROIC subarray 202, such as for connection to perimeter circuitry like analog-to-digital converters that support the functionality of the overall circuit. Each of the ROIC subarrays is constrained on buttability due to internal circuitry that allows for numerous operations that are not typically routed in the active area and hence extend the size of the ROIC subarray in one or more dimensions, e.g., the ROIC subarray is larger at least in one dimension than the one or more detectors 204. The active area of each ROIC subarray may include physical space, e.g., for wirebond pads to enable input biases, clocks, output video lines, and circuitry routing, e.g., for column-or row-based operations often column-based analog to digital conversion. The at least one unbuttable side 210 allows for a less complex design compared to four-sided buttable arrays, such as tiled arrays or mosaic arrays, which can require through vias to facilitate required electrical contacts in the center of each array.

In operation, light, e.g., IR radiation 108, from a scene can enter the main optical window 106 of the integrated dewar assembly 100 and can be incident on the one or more ROIC subarrays 202. The incident IR radiation 108 can excite pixels of the one or more detectors 204, which can convert the IR radiation 108 into a plurality of detected electrical charges. The ROIC subarray 202 can measure the plurality of detected electrical charges over a specified interval and output electrical signals proportional to the charge. These output electrical signals can form the data output signals that are passed on the electrical wires 116 through the walls of the cryogenic chamber 102 to an external receiver for additional processing.

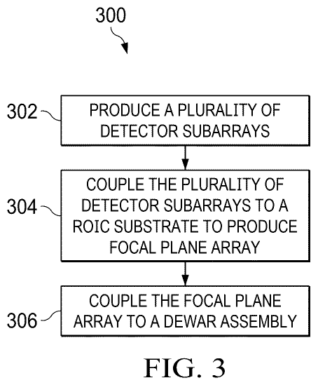

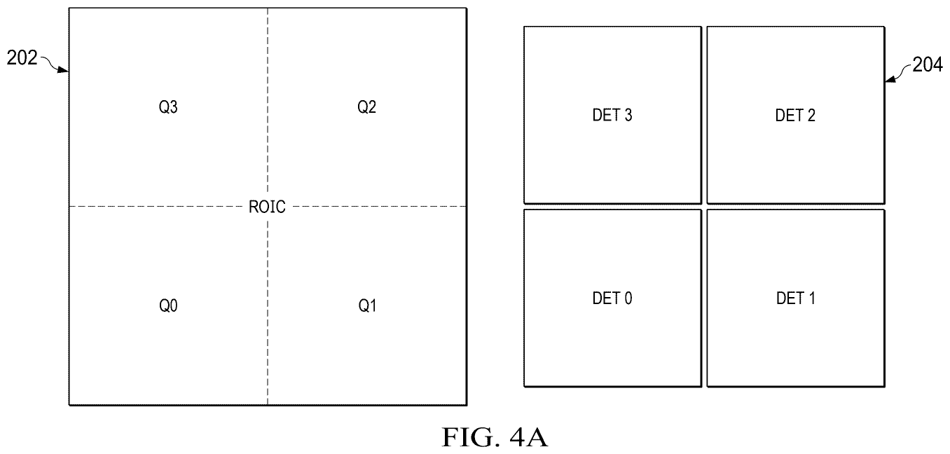

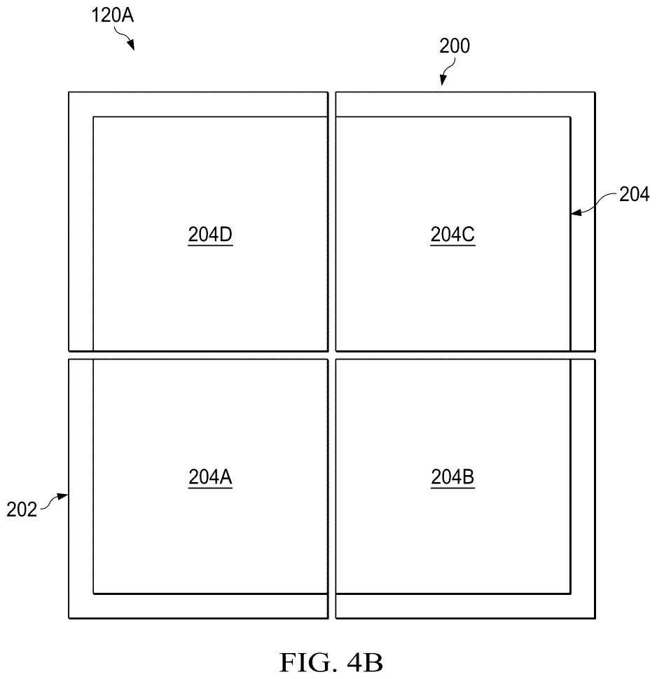

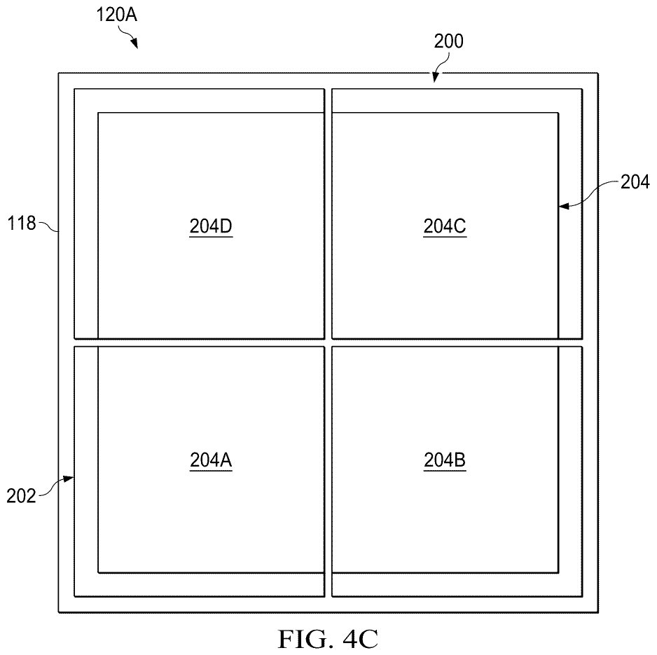

FIG. 3 illustrates an example method 300 of producing an ultra large format focal plane array assembly in accordance with this disclosure. FIGS. 4A, 4B, and 4C illustrate an example focal plane array assembly undergoing the method 300 of FIG. 3 in accordance with this disclosure.

As shown in FIG. 3, the method 300 begins by producing a plurality of detectors, such as the plurality of ROIC subarrays 202, in operation 302. Rather than being a single large format detector die as in traditional approaches, the ROIC subarrays 202 are smaller substrates that improve material growth during manufacturing and improve processing yields. For example, the ROIC subarrays 202 may be grown or manufactured while being electrically isolated from each other to produce the plurality of ROIC subarrays 202.

In operation 304, each of the ROIC subarrays 202 are coupled to at least one of a one or more detectors 204, to produce a large format focal plate array, such as the focal plane array assembly 120A. For example, the at least one unbuttable side 210 of each ROIC subarrays 202 may be used to form a plurality of gaps 208 disposed between the plurality of buttable sides 206, where the gaps 208 are configured to electrically isolate adjacent ROIC subarrays 202 of the plurality of ROIC subarrays 202. In some cases, the detectors 204 may be coupled to the ROIC subarray 202 using a hybridization process as shown in FIGS. 4A and 4B.

In some cases, multiple ROIC subarrays 202 may be small ROIC substrates that do not, by themselves, yield a full large format array but are capable of yielding smaller subarrays. For example, each of the subarrays may be 6,000 element-by-6,000 element arrays, rather than a full monolithic 12,000 element-by-12,000 element array. The smaller size of the ROIC subarrays 202 allow for improved fabrication yields, leading to lower yield losses. Manufacturing and processing of ROIC substrates may result in unavoidable physical defects across the substrate. For example, these defects may result in electrical shorts, causing a die to fail. With a large amount of dies per wafer, an electrical short on a single die may result in acceptable yield loss. Thus, even if an unavoidable physical defect in a ROIC subarray 202 occurs such that the corresponding subarray fails, other subarrays of the FPA may pass.

In some embodiments, the one or more ROIC subarrays 202 are coupled to one or more detectors 204 using the at least one unbuttable side 210 of each of the ROIC subarrays 202; In some embodiments, the gaps 208 disposed between the plurality of buttable sides 206 of adjacent ROIC subarrays 202 are configured to electrically isolate adjacent ROIC subarray 202 of the one or more ROIC subarray 202.

In other embodiments, the ROIC subarrays 202 may be hybridized to as single large detector (not shown). In these embodiments, each of the ROIC subarrays 202 are still electrically isolated from each other via the plurality of gaps 208.

In operation 306, the focal plane array assembly 120A may be coupled to a system, such as a dewar assembly. For example, the focal plane array assembly 120A may be wire bonded to a fanout or motherboard, such as the interposer 118, and integrated into the dewar assembly as shown in FIG. 4C.

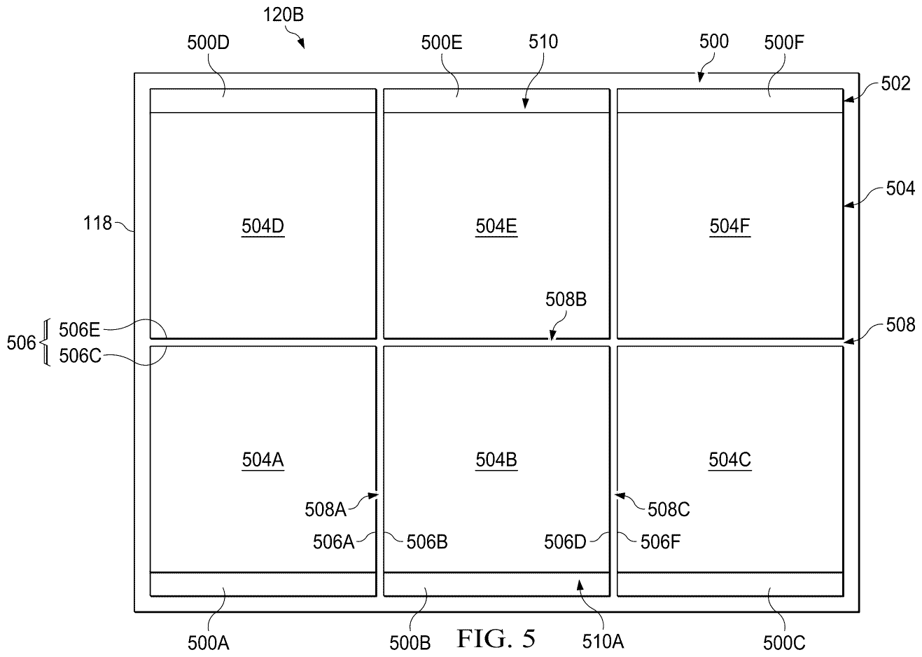

FIG. 5 illustrates another example focal plane array assembly 120B in accordance with this disclosure. For example, the focal plane array assembly 120B may be part of the integrated dewar assembly 100 of FIG. 1. The focal plane array assembly 120B may also be configured similarly as the focal plane array assembly 120A of FIG. 2, except as otherwise described below.

As shown in FIG. 5, the focal plane array assembly 120B can include a plurality of subarrays 500. In this example, the focal plane array assembly 120B is an ultra large format FPA that includes six subarrays 500A-500F. Each of the plurality of subarrays 500 can be a three-side buttable array and may include a ROIC subarray 502 electrically coupled to one of a plurality of detectors 504. Although only six subarrays are shown, any desired number of three-side buttable arrays may be used to form an ultra large format FPA, such as 8 or more, 10 or more, or 12 or more. The plurality of detectors 504 may include a first detector 504A, a second detector 504B, a third detector 504C, a fourth detector 504D, a fifth detector 504E, and a sixth detector 504F. In some cases, each of the plurality of detectors 504 may include a 4,000 element-by-4,000 element array (such as one having about 4,000 rows and 4,000 columns) or a 6,000 element-by-6,000 element array, and the arrays may be disposed adjacent to each other on the ROIC subarray 502.

Each of the one or more ROIC subarrays 502 may include a plurality of buttable sides 506, such as buttable sides 506A-506D, adjacent to a plurality of gaps 508. The gaps 508 electrically isolate adjacent ROIC subarray 502 from each other. In some cases, the gaps 508 may be electrical isolation gaps, such as electrical termination, between adjacent detectors of the one or more ROIC subarrays 502 such that the FPA may be diced. Each of the ROIC subarrays 502 may also include an unbuttable side 510 that is not adjacent to other detectors, such as an unbuttable side 510A.

Among other things, this disclosure allows for ultra large format focal plane arrays that have improved yields with reduced or minimal gaps in captured images. For example, embodiments of this disclosure produce ultra large format focal plane arrays that use two-side or three-side buttable subarrays to maintain traditional ROIC designs and integration techniques with space for peripheral circuitry while significantly improving yields.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A focal plane array assembly comprising:
a plurality of subarrays that are electrically isolated, each of the plurality of subarrays comprising:
one or more detectors; and
one or more readout integrated circuit (ROIC) subarrays coupled to the one or more detectors;
wherein each ROIC subarray comprises:
a plurality of buttable sides; and
at least one unbuttable side configured to electrically couple to an interposer or a connector for providing an input to or output from the ROIC subarray.

2. The focal plane array assembly of claim 1, wherein each detector of the one or more detectors includes a 4,000 element-by-4,000 element or larger array.

3. The focal plane array assembly of claim 1, wherein the plurality of subarrays includes a first detector, a second detector, a third detector, and a fourth detector.

4. The focal plane array assembly of claim 3, wherein:
the plurality of buttable sides of each ROIC subarray includes a first buttable side and a second buttable side; and
the at least one unbuttable side of each ROIC subarray includes a first unbuttable side and a second unbuttable side.

5. The focal plane array assembly of claim 3, wherein the plurality of subarrays includes a fifth detector and a sixth detector.

6. The focal plane array assembly of claim 5, wherein the plurality of buttable sides of each ROIC subarray includes a first buttable side, a second buttable side, and a third buttable side.

7. The focal plane array assembly of claim 1, wherein the at least one unbuttable side of each ROIC subarray includes additional peripheral circuitry and input/output pads that are coplanar with the ROIC subarray and is non-coplanar with the one or more detectors.

8. An integrated dewar assembly comprising:
an interposer; and
a focal plane array assembly coupled to the interposer, the focal plane array assembly comprising:
a plurality of subarrays that are electrically isolated, each of the plurality of subarrays comprising:
one or more detectors; and
one or more readout integrated circuit (ROIC) subarrays coupled to the one or more detectors;
wherein each ROIC subarray comprises:
a plurality of buttable sides; and
at least one unbuttable side configured to electrically couple to an interposer or a connector for providing an input to or output from the ROIC subarray.

9. The integrated dewar assembly of claim 8, wherein each detector of the one or more detectors includes a 4,000 element-by-4,000 element or larger array.

10. The integrated dewar assembly of claim 8, wherein the plurality of subarrays includes a first detector, a second detector, a third detector, and a fourth detector.

11. The integrated dewar assembly of claim 10, wherein:
the plurality of buttable sides of each ROIC subarray includes a first buttable side and a second buttable side; and
the at least one unbuttable side of each ROIC subarray includes a first unbuttable side and a second unbuttable side.

12. The integrated dewar assembly of claim 10, wherein the plurality of subarrays includes a fifth detector and a sixth detector.

13. The integrated dewar assembly of claim 12, wherein the plurality of buttable sides of each ROIC subarray includes a first buttable side, a second buttable side, and a third buttable side.

14. The integrated dewar assembly of claim 8, wherein the at least one unbuttable side of each ROIC subarray includes additional peripheral circuitry and input/output pads that are coplanar with the ROIC subarray and is non-coplanar with the one or more detectors.

15. A method comprising:
producing one or more readout integrated circuit (ROIC) subarrays, each of the one or more ROIC subarrays comprising a plurality of buttable sides and at least one unbuttable side configured to electrically couple to an interposer or a connector for providing an input to or output from the ROIC subarray; and
coupling the plurality of ROIC subarrays to one or more detectors using the at least one unbuttable side of each of the ROIC subarrays to form a plurality of subarrays of a focal plane array (FPA), wherein the plurality of subarrays of the FPA are electrically isolated through gaps disposed between the plurality of buttable sides of adjacent ROIC subarrays.

16. The method of claim 15, wherein each detector of the one or more detectors includes a 4,000 element-by-4,000 element or larger array.

17. The method of claim 15, wherein the plurality of subarrays includes a first detector, a second detector, a third detector, and a fourth detector.

18. The method of claim 17, wherein:
the plurality of buttable sides of each ROIC subarray includes a first buttable side and a second buttable side; and
the at least one unbuttable side of each ROIC subarray includes a first unbuttable side and a second unbuttable side.

19. The method of claim 15, wherein:
the plurality of subarrays includes a fifth detector and a sixth detector; and
the plurality of buttable sides of each ROIC subarray includes a first buttable side, a second buttable side, and a third buttable side.

20. The method of claim 15, wherein the at least one unbuttable side of each ROIC subarray includes additional peripheral circuitry and input/output pads that are coplanar with the ROIC subarray and is non-coplanar with the one or more detectors.
